(19) United States
(12) Patent Application Publication
(10) Pub. No.: US 2015/0365216 A1
(43) Pub. Date: Dec. 17, 2015

(54) WIRELESS COMMUNICATION DEVICES AND METHODS FOR PERFORMING A PACKET-SWITCHED (PS) SERVICE APPLIED TO A MOBILE COMMUNICATIONS DEVICE WITH MULTIPLE SUBSCRIBER IDENTITY MODULES (SIMS)

(71) Applicant: Media Tek Inc., Hsin-Chu (TW)

(72) Inventors: Peng-An CHEN, Taipei City (TW); Yi-Ting CHENG, Taipei City (TW)

(21) Appl. No.: 14/304,081

(22) Filed: Jun. 13, 2014

(51) Int. Cl. H04L 5/00; H04B 1/3816; H04L 12/721; H04W 72/04

(52) U.S. Cl. CPC H04L 5/0053; H04W 72/0453; H04B 1/3816; H04L 45/66

(57) ABSTRACT

A wireless communication method for performing a packet-switched (PS) data service in a mobile communications device with a plurality of subscriber identity modules (SIM) is provided. A PS service is first performed with a first subscriber identity module. During performing the PS service with the first subscriber identity module, it is then determined packet loss status regarding whether a packet in the downlink transmission have been successfully received. A frequency for receiving signals on control channel or circuit-switched channel associated with the first subscriber identity module or signals on control channel or circuit-switched channel or packet-switched channel associated with a second subscriber identity module is adaptively adjusted according to the determination result while performing the PS service with the first subscriber identity module.

### BACKGROUND OF THE INVENTION

1. Field of the Invention

The invention generally relates to wireless communication systems and wireless communication methods thereof, and more particularly, to wireless communication systems and wireless communication methods for performing a packet-switched (PS) data service applied to a mobile communications device with multiple subscriber identity modules (SIMs) and one or more radio frequency module shared by the subscriber identity modules.

2. Description of the Related Art

Recently, portable devices, such as mobile or handheld devices, have become more and more technically advanced and multifunctional. For example, a mobile device may receive email messages, have an advanced address book management application, allow for media playback, and have various other functions. Because of the conveniences of portable devices with multiple functions, the devices have become necessities of life. As technology advances, mobile devices adapted for multiple subscriber numbers, dual-card or multiple-card have been developed, which generally have two or more wireless communication modules for respectively performing wireless transmission and reception with an individual subscriber number, are now becoming available to end users. For example, a Dual SIM Dual Standby (DSDS) device comprises means for receiving/sending messages associated with at least two subscriber identity modules (SIMs). The at least two SIMs may be associated with the same or different cellular networks, and may be using the same or different Radio Access Technologies (RAT), such as the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA 2000) technology, Time Division-Synchronous Code Division Multiple Access (TD-SCDMA) technology, Worldwide Interoperability for Microwave Access (WiMAX) technology, Long Term Evolution (LTE) technology, Universal Mobile Telecommunications System (UMTS) technology, short range wireless technology such as WLAN (e.g., WiFi) technology, Bluetooth technology, and others.

The dual-card or multiple-card design allows the SIMs to be active simultaneously and allows calls to be received on either subscriber numbers associated with one of the SIMs at any time. For the dual-card or the multiple-card cellular phones with one or more transceivers, if there are more than one SIMs share a single transceiver, only one SIM is allowed to obtain network resources using the single transceiver, while the other SIM has no control over the single transceiver. For example, a dual-card cellular phone may be configured such that the single transceiver is occupied by the first SIM for performing a packet-switched (PS) data service, e.g. the Multimedia Messaging Service (MMS). While the dual-card cellular phone is performing the PS service with the first SIM, a second SIM may constantly interrupt the PS service in order to gain the control of the single transceiver for performing radio measurements which allows the SIM to maintain mobility or receive network messages, such as a paging message. As a result, the PS data rate or data throughput of the PS service would be damaged and Mobile Terminated (MT) call setup rate (e.g. in terms of incoming call reception rate) may be poor from the user point of view.

### BRIEF SUMMARY OF THE INVENTION

Accordingly, embodiments of the invention provide wireless communication systems and wireless communication methods for performing a packet-switched (PS) service applied to a mobile communications device with multiple subscriber identity modules (SIMs) and multiple radio frequency modules which are shared among several subscriber identity modules. In one aspect of the invention, a wireless communication method for performing a packet-switched (PS) service in a mobile communications device with a plurality of subscriber identity modules (SIM) is provided. A PS service is first performed with a first subscriber identity module. During performing the PS service with the first subscriber identity module, it is then determined whether a packet loss status regarding whether a packet in the downlink transmission have been successfully received. A frequency for receiving signals on control channel or circuit-switched channel associated with the first subscriber identity module or signals on control channel or circuit-switched channel or packet-switched channel associated with a second subscriber identity module is adaptively adjusted according to the determination result while performing the PS service with the first subscriber identity module.

In another aspect of the invention, a mobile communications device is provided which comprises a processing unit. The processing unit is arranged for performing a packet-switched (PS) service with a first subscriber identity module, determining a packet loss status regarding whether a packet in the downlink transmission have been successfully received during performing the PS service with the first subscriber identity module, and adaptively adjusting a frequency for receiving signals on control channel or circuit-switched channel associated with the first subscriber identity module or signals on control channel or circuit-switched channel or packet-switched channel associated with a second subscriber identity module according to the determination result while performing the PS service with the first subscriber identity module.

Other aspects and features of the present invention will become apparent to those with ordinarily skill in the art upon review of the following descriptions of specific embodiments of wireless communication systems and wireless communication methods for performing a packet-switched (PS) service applied to a mobile communications device with multiple SIMs.

### BRIEF DESCRIPTION OF DRAWINGS

The invention can be more fully understood by reading the subsequent detailed description and examples with references made to the accompanying drawings, wherein:

FIG. 1 is a block diagram illustrating a wireless communication system according to an embodiment of the invention;

FIG. 2 is a flow chart illustrating a wireless communication method for performing a PS service according to an embodiment of the invention;

FIG. 3 is a flow chart illustrating a wireless communication method applied to a mobile communications device with a plurality of SIMs for adjusting a paging period associated with the second subscriber identity module while performing a PS service with the first subscriber identity module according to another embodiment of the invention; and

FIG. 4 is a flow chart illustrating a frequency adjustment method applied to increase or decrease the frequency for receiving signals on the control channel or circuit-switched channel associated with the second subscriber identity module according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense.

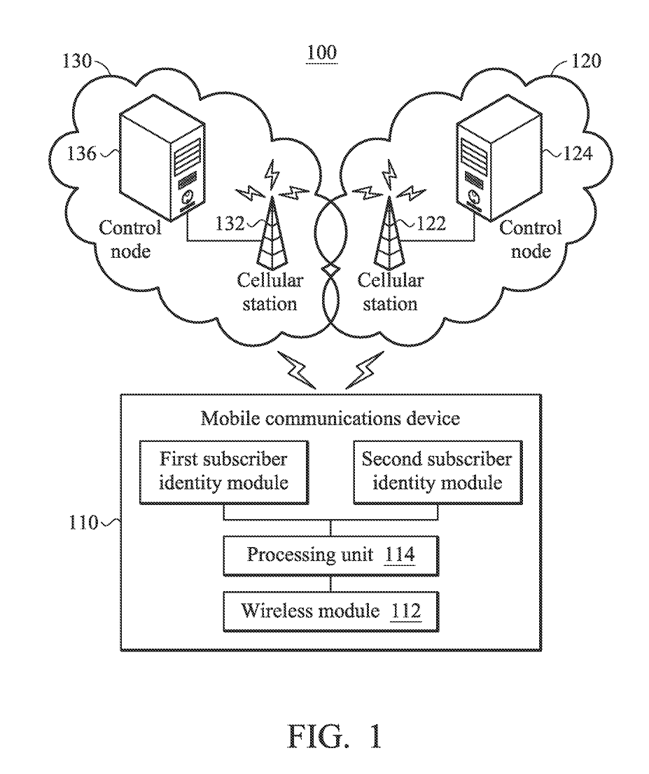

FIG. 1 is a block diagram illustrating a mobile communications environment according to an embodiment of the invention. In the mobile communications environment 100, the mobile communications device 110 is wirelessly connected to the cellular station 122 of the service network 120 and the cellular station 132 of the service network 130 for obtaining wireless services. Generally, the cellular station 122 may be referred to as a base station, a cell or an access station, or may be referred to as an Home Node-B (HNB) in a WCDMA network or a Home e-Node-B (HeNB) in an LTE network, which is controlled by the control node 124 to provide the functionality of wireless transceiving for the service network 120. Similarly, the cellular station 132 may be referred to as a base station, a cell or an access station, or may be referred to as an HNB in a WCDMA network or a HeNB in an LTE network, which is controlled by the control node 134 to provide the functionality of wireless transceiving for the service network 130.

The mobile communications device 110 is referred to as a user equipment (UE) or a mobile station (MS), supporting the abovementioned RATs, and can be a device such as a mobile phone, a computer system, etc. The mobile communications device 110 comprises a wireless module 112 for performing the functionality of wireless transmissions and receptions to and from the cellular station 122 or the cellular station 132. To further clarify, the wireless module 112 may comprise a baseband unit (not shown) and a radio frequency (RF) unit (not shown). The baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the wireless communications system, wherein the radio frequency may be 900 MHz, 1900 MHz, or 2100 MHz utilized in WCDMA systems, or may be 900 MHz, 2100 MHz, or 2.6 GHz utilized in LTE systems, or others depending on the RAT in use. Also, the mobile communications device 110 further comprises a processing unit 114 for controlling the operation of the wireless module 112 and other functional components, such as a display unit and/or keypad serving as the MMI (man-machine interface), a storage unit storing the program codes of applications or communication protocols, or others. In one embodiment, the service network 120 may be a WCDMA network and the mobile communications device 110 may be a UE in compliance with the 24.008 specification and other related specifications of the WCDMA technology. In another embodiment, the service network 130 may be an LTE network and the mobile communications device 110 may be a UE in compliance with the 3GPP TS 24.301 specification and other related specifications of the LTE technology. Alternatively, the mobile communications device 110 may be a UE or MS in compliance with both of the specifications of the WCDMA and LTE communication protocols, and the invention is not limited thereto.

The mobile communications device 110 may further comprise at least two subscriber identity modules (SIMs), a first SIM and a second SIM, which may be associated with the same or different cellular networks, and may be using the same or different abovementioned RATs. The RF unit can be shared by the first and second SIMs. When the RF unit (e.g. the single transceiver) is occupied by one SIM (also referred to an active SIM), only the occupied one is allowed to obtain network resources using the RF unit, while the other SIM (also referred to an idle SIM) has no control over the RF unit.

To be more specific, the processing unit 114 controls the wireless module 112 for performing a PS service (e.g. the MMS or VoIP) with the service network 120 using one SIM and receiving signals or messages on the control channel or other signaling channels (e.g. paging channel) with the service network 130 using the other SIM via the cellular station 122 and/or the cellular station 132, respectively.

Note further that in some embodiments of the invention, the mobile communications device 110 may further be extended to comprise more than two SIMs, and more than one transceiver; the invention should not be limited what is shown in FIG. 1.

As previously discussed, for a mobile communications device with at least two SIMs and a single transceiver (e.g. a RF unit) shared by the two SIMs, while the mobile communications device is performing the PS service (e.g. a PS data service or VoIP) with the first SIM, a second SIM may constantly interrupt the PS service in order to gain the control of the single transceiver for performing radio measurements or receiving network messages on control channels or other signaling channels, such as a paging message on a paging channel, and thus the PS data rate or data throughput of the PS service would be damaged and the performance of MT call setup (e.g. in terms of incoming call reception rate) may be poor. According to the embodiments of the invention, since the mobile communications device is equipped with at least two SIMs and each is capable of providing predetermined communications services in compliant with a predetermined RAT, the methods for adjusting a frequency for receiving signals or message on the control channels (e.g. the paging channel) to achieve a goal for one SIM to listen to the paging signals without breaking the PS data transmission of the other SIM operating in the connected mode are introduced.

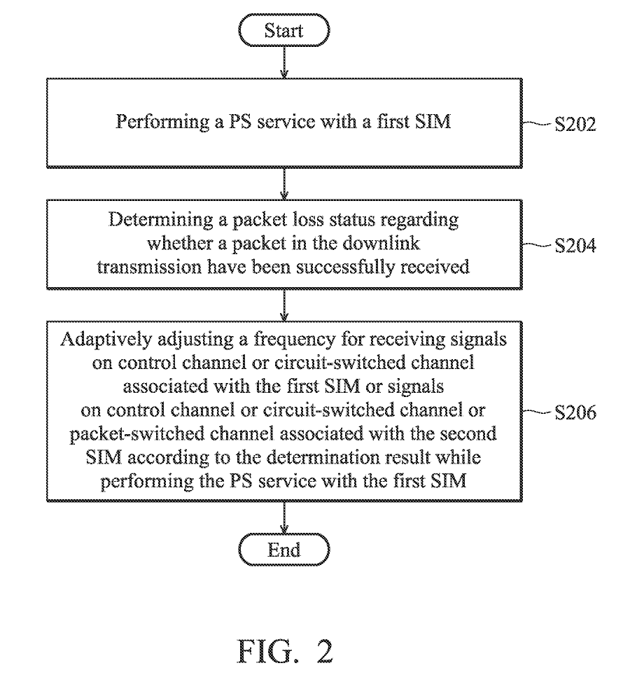

FIG. 2 is a flow chart illustrating a wireless communications method for performing a PS service applied to a mobile communications device with a plurality of SIMs according to an embodiment of the invention. The method can be applied to the mobile communications device 110 and performed by the processing unit 114 of the mobile communications device 110 as shown in FIG. 1. In this embodiment, the mobile communications device 110 may comprise first and second SIMs and the PS service can be a PS data service or other PS services such as the VoIP service and the invention is not limited thereto.

First, in step S202, a PS service (e.g. the MMS or the VoIP) is first performed with a first SIM. During performing the PS service with the first SIM, in step S204, it is then determined, by the processing unit 114, whether a packet in the downlink transmission which is data transmission from the service network to the mobile communications device 110 have been successfully received. For example, the packet may be a Layer 2 packet, such as a Layer 2 data packet for radio link control (RLC), PDCP or LLC layer, configured in an unacknowledged mode, but the invention is not limited thereto. Note that the layer 2 data packet may comprise data packet for at least one of the Media Access Control (MAC), the Radio Link Control (RLC) and the Packet Data Convergence Protocol (PDCP) layers.

After that, in step S206, a frequency for receiving signals on a control channel (e.g. the paging channel) or a circuit-switched channel associated with the first subscriber identity module or signals on control channel or circuit-switched channel or packet-switched channel associated with the second SIM is adaptively adjusted according to the determination result while performing the PS service with the first SIM. It is to be noted that, in some embodiments, signals on a control channel or a PS channel associated with the second SIM may be received when the second SIM is connected to the LTE network.

In this embodiment, the frequency for receiving signals on the control channel or circuit-switched channel of the first SIM or the second SIM may be decreased when the packet loss status indicates that the data packet in the downlink transmission is not received successfully or it may be increased when the packet loss status indicates that at least a number of data packets in the downlink transmission have been successfully received. However, it is understood that the invention is not limited thereto.

In some embodiments, the frequency for receiving signals on the control channel (e.g. the paging channel) or circuit-switched channel associated with the second SIM (e.g. a paging period) may be increased or decreased according to a predetermined formula or algorithm. In one embodiment, if the control channel is the paging channel, the frequency for receiving signals on the control channel associated with the second SIM can be referred to as the paging period associated with the second SIM and the frequency can increased or decreased by shortening or extending the paging period, respectively. For example, the frequency can be increased by shorting the paging period t to a smaller paging period T=0.5*t, which means that the adjusted paging period T is half of the previous paging period t. Similarly, in one embodiment, the frequency can be decreased by extending the paging period t to a longer paging period T=2*t, which means that the adjusted paging period T is the double of the previous paging period t. After the paging period is adjusted, the processing unit 114 may perform subsequent paging procedures using the adjusted paging period. For example, if the paging period t is shortened to a smaller paging period T=0.5*t, the processing unit 114 may perform next paging procedure using the adjusted paging period 0.5*t. In this case, the time needed for next paging period is only half of that for current paging period. Therefore, by shortening or extending the paging period, the processing unit 114 can adaptively adjust the frequency (e.g. the paging period) for receiving signals on the paging channel associated with the second SIM based on the packet loss status for a data packet in the downlink transmission respectively.

In some embodiments, the frequency for receiving signals on the control channel or circuit-switched channel of the second SIM can also be performed when the packet loss status indicates a ratio that at least a number of data packets (e.g. 10 data packets) which are received in the downlink transmission can be decoded successfully has exceeded a predetermined ratio.

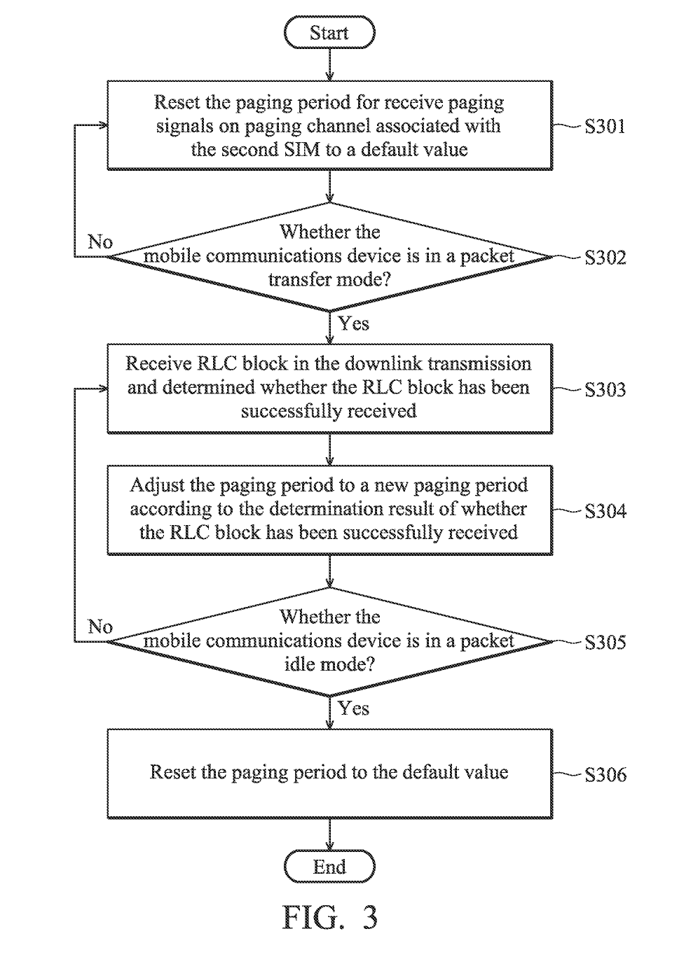

FIG. 3 is a flow chart illustrating a wireless communications method for performing a PS service applied to a mobile communications device with a plurality of SIMs for adjusting a paging period associated with the second subscriber identity module while performing a PS service with the first subscriber identity module according to an embodiment of the invention. The method can be applied to the mobile communications device 110 and performed by the processing unit 114 of the mobile communications device 110 as shown in FIG. 1. In this embodiment, the paging channel associated with the second SIM is to be listened to receive paging signals with a frequency (e.g. a paging period) while the PS service is performed with the first SIM.

First, in step S301, the paging period for receive paging signals on paging channel associated with the second SIM is reset or configured to a default value which may be, for example, configured by the service network (e.g. the service network 130).

It is then determined whether the mobile communications device 110 is in a packet transfer mode (step S302). That is, it is determined whether the mobile communications device 110 is performing the PS service.

If the mobile communications device 110 is not in the packet transfer mode (No in step S302), the process backs to step S301 to reset the paging period to the default value and the paging period keeps unchanged.

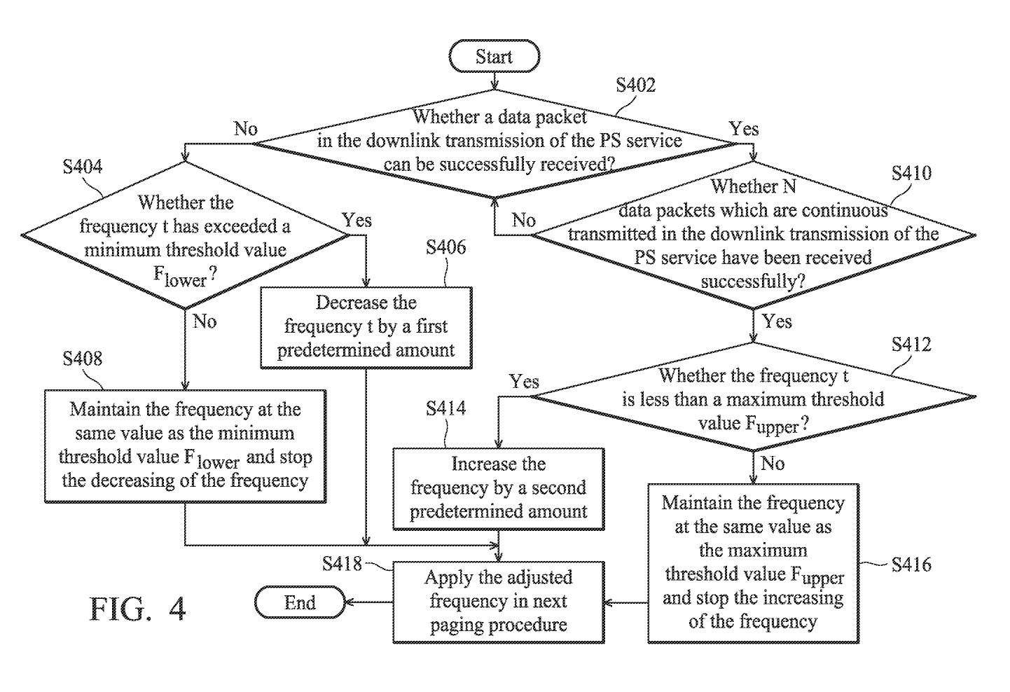

Contrarily, if the mobile communications device 110 is in the packet transfer mode (Yes in step S302), which means that the mobile communications device 110 is performing the PS service, it is then received layer 2 data packet (e.g. a RLC block) in the downlink transmission and determined whether the RLC block has been successfully received (step S303). It is understood that, when receiving the RLC block from the service network, the RLC block may be successfully received from the service network or it may be lost for certain reasons. Then, the paging period is adjusted to a new paging period according to the determination result of whether the RLC block has been successfully received (S304). The paging period may be adaptively adjusted to an adjusted paging period according to the determination result. Adjustment of the paging period according to the determination result will be detailed in the following with reference to FIG. 4.

After that, it is then determined whether the mobile communications device 110 is in a packet idle mode (step S305). That is, it is determined whether the mobile communications device 110 has terminated the PS service.

If the mobile communications device 110 is not in the packet idle mode (No in step S305), which means that the PS service is ongoing, the process flow backs to step S304 to receive next RLC block in the downlink transmission and determine whether the next RLC block has been successfully received and then adjust the paging period to a new paging period according to the determination result.

If the mobile communications device 110 is in the packet idle mode (Yes in step S305), which means that the PS service is terminated, it is then reset the paging period to the default value to end the process (step S306).

FIG. 4 is a flow chart illustrating a frequency adjustment method applied to increase or decrease the frequency for receiving paging signals or messages on the paging channel associated with the second SIM while performing the PS service with the first SIM according to another embodiment of the invention. The method can be applied to the mobile communications device 110 of the wireless communications system as shown in FIG. 1.

First, in step S402, the processing unit 114 determines whether a data packet in the downlink transmission of the PS service can be successfully received. Note that, in this embodiment, the processing unit 114 may periodically perform a paging procedure for receiving paging signals or messages on the paging channel associated with the second SIM with a predetermined frequency. In this embodiment, assuming that a predetermined frequency t for receiving paging signals or messages on the paging channel associated with the second SIM is set to be every 100 ms performs once. Conventionally, the frequency (or the period period) t is fixed. That is, the processing unit 114 may set a timer to count the number of the paging period and performs the paging procedure with the second SIM to receive paging signals or messages on the paging channel associated with the second SIM when the paging period has expired.

When determining that the data packet in the downlink transmission of the PS service cannot be successfully received (i.e. the data packet is lost) (No in step S402), in step S404, the processing unit 114 further determines whether the frequency t has exceeded a minimum threshold value F_{lower}. For example, the minimum threshold value F_{lower} may be predetermined determined or may be configured based on the specification and network requirements, but it is not limited thereto.

If the frequency t is higher than the minimum threshold value F_{lower} (Yes in step S404), in step S406, the frequency period t is shortened by a first predetermined amount. For example, if the frequency is set to be 10 times within a predetermined time period by default and the F_{lower} is set to be 5, the frequency t can be adjusted to a lower frequency 5-9 times within the predetermined time period to perform the paging procedure with a longer page period so as to improve the PS data rate. It is to be understood that, in some embodiments, the shortened frequency may be further compared with the minimum threshold value F_{lower} and may be set to the minimum threshold value F_{lower} once its value is less than the F_{lower}.

Contrarily, if the frequency t is equal to or less than the minimum threshold value F_{lower} (No in step S404), in step S408, the minimum threshold value of the frequency has reached and thus it will maintain at the same value as the minimum threshold value F_{lower} (i.e. the frequency t will be adjusted to the minimum threshold value F_{lower}) and the decreasing of the frequency t will be stopped.

On the other hand, when determining that the data packet in the downlink transmission of the PS service is successfully received (Yes in step S402), in step S410, the processing unit 114 may further determine whether at least a number of data packets in the downlink transmission have been successfully received. In this step, the processing unit 114 may determine whether N (N>0) data packets which are continuous transmitted in the downlink transmission of the PS service have been received successfully. If it is determined that there is less than N continuous transmitted data packets received successfully (No in step S410), the process backs to step S402 and the frequency t will keep unchanged. When determining that there is at least N continuous transmitted data packets received successfully (Yes in step S410) the processing unit 114 further determines that whether the frequency t is less than a maximum threshold value Fᵤₚₚₑᵣ (step S412). The maximum threshold value Fᵤₚₚₑᵣ may be predetermined or may be configured based on the specification and network requirements, for example.

If the frequency t is less than the maximum threshold value Fᵤₚₚₑᵣ (Yes in step S412), in step S414, the frequency is increased by a second predetermined amount. It is to be understood that, in some embodiments, the increased frequency may be further compared with the maximum threshold value Fᵤₚₚₑᵣ and may be set to the maximum threshold value Fᵤₚₚₑᵣ once its value exceeds the Fᵤₚₚₑᵣ. For example, if the frequency is set to be 10 times within a predetermined time period by default and the Fᵤₚₚₑᵣ is set to be 20, the frequency t can be adjusted to a higher frequency 11-20 times within the predetermined time period to perform the paging procedure with a shorter page period so as to improve the performance of MT call setup.

Contrarily, if the frequency t has exceeded or equals to the maximum threshold value Fᵤₚₚₑᵣ (No in step S412), in step S416, the maximum threshold value of the frequency has reached and thus it will be maintained at the same value as the maximum threshold value Fᵤₚₚₑᵣ (i.e. the frequency t will be adjusted to the maximum threshold value Fᵤₚₚₑᵣ) and the increasing of the frequency will be stopped.

After the adjustment of the frequency has completed, in step S418, the adjusted frequency will be further applied in next paging procedure. For example, if the frequency is extended to a higher frequency with a shorter paging period T=0.5*t, the processing unit 114 may perform next paging procedure using the adjusted paging period 0.5*t. In this case, the time needed for next search will be the half of current paging and the performance of MT call setup can be enhanced.

For explanation, one specific embodiment is illustrated in the following to explain the detailed process of a method of the invention, and those skilled in the art will understand that this specific embodiment is used for explanation only and the invention is not limited thereto. In some embodiments, the processing unit 114 may determine whether to adjust a paging period during performing the PS service according to a packet loss status or packet receiving status of Layer 2 (L2) data packet in the receiving of the packet (i.e. in the downlink transmission).

In one embodiment, it is assumed that a frequency for receiving paging or control channel is set to X by default and the Fᵤₚₚₑᵣ and F_{lower} are predefined threshold values, wherein Fᵤₚₚₑᵣ is a maximum threshold value for increasing the frequency for receiving paging or control channel and F_{lower} is a minimum threshold value for decreasing the frequency for receiving paging or control channel.

It is to be noted that, the performance of Mobile Terminated (MT) call setup (e.g. the incoming call reception rate) cannot be enhanced if the frequency for receiving paging or control channel of other SIMs is set to be exceeded the Fᵤₚₚₑᵣ. On the other hand, the performance of MT call setup may be significantly degraded in view of user point if the frequency for receiving paging or control channel of other SIM cards is set to be less than the F_{lower}. Therefore, the frequency for receiving paging or control channel of other SIMs is set to a value between the F_{lower} and the Fᵤₚₚₑᵣ to maintain the performance of MT call setup.

In one embodiment, the frequency for receiving paging or control channel of other SIMs can be decreased when detecting a L2 packet lost. The decrement of the frequency is limited by the F_{lower}. Contrarily, the frequency for receiving paging or control channel of other SIMs can be increased when detecting N continuous packets have been successfully received. The increment of the frequency is limited by the Fᵤₚₚₑᵣ.

Embodiments of the invention are not limited to 2G radio communication systems, but are also applicable to 3G/LTE radio communication systems and to any other suitable existing or future communication standards. Taking the 2G radio communication system as an example, in one embodiment, assume that the service network pages a MS (e.g. the mobile communications device 110) by the Common Control Channel (CCCH) and is in Discontinuous Reception (DRX) mode, then the Fᵤₚₚₑᵣ can be set to

Fᵤₚₚₑᵣ=1/(BS_PA_MFRMS*51)(units in 1/frame),

wherein BS_PA_MFRMS (3 bits: 2—9) represents the number of 51-multiframes between transmission of paging messages to mobile communications devices of the same paging group.

In another embodiment, assume that the service network pages the MS by the Packet Common Control Channel (PCCCH) which comprises of logical channels for GPRS common control signalling and is in the DRX mode, then the Fᵤₚₚₑᵣ can be set to

Fᵤₚₚₑᵣ=1/(the number of PCCCH*the number of paging blocks available on one PCCCH*64) (units in 1/frame).

In another embodiment, it is assumed that the service network will retransmit a paging for M times, wherein M can be obtained by the existed technique (e.g., smart paging). If M=0, then the F_{lower} can be set to equal to the Fᵤₚₚₑᵣ. If M>=1, assume that K be the number of paging block listened by the MS among M+1 transmissions, the probability of receiving paging is 1−(BLER_CCCH)^{K}.

If the target MT call successful rate is set to at least Y, then K should be set to

$$K = Ceiling ( log ( 1 - Y ) / log ( BLER\_CCCH ) ) and$$

$$\begin{matrix}{F}_{lower} = {F}_{upper} / K \\ = {F}_{upper} / ( Ceiling ( log ( 1 - Y ) / log ( BLER\_CCCH ) ) ) ,\end{matrix}$$

wherein Y can be set or determined by the performance requirement of the MT call.

In summary, according to methods for performing a PS service in a mobile communications device with multiple SIMs and related mobile communications devices and systems, while performing the PS service with a first SIM, the frequencies for receiving signals on the control channel (e.g. the paging channel) or other signaling channels such as circuit-switched channel or PS channel associated with other SIMs can be adaptively adjusted according to a packet loss or receiving status of data packets in the downlink transmission of the PS service detected on the first SIM, thus providing an adaptive paging mechanism and maximizing or enhancing the PS data rate and the performance of MT call setup while maintaining the mobility in the network for the idle SIMs.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the above discussed function. The one or more processors can be implemented in numerous ways, such as with dedicated hardware, or with general purpose hardware that is programmed using microcode or software to perform the functions recited above.

Wireless communication methods for performing a PS service and systems thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless communication method for performing a packet-switched (PS) service in a mobile communications device with a plurality of subscriber identity modules (SIM), comprising:
performing a packet-switched service with a first subscriber identity module;
determining a packet loss status regarding whether a packet in the downlink transmission have been successfully received during performing the packet-switched service with the first subscriber identity module; and
adaptively adjusting a frequency for receiving signals on control channel or circuit-switched channel associated with the first subscriber identity module or signals on control channel or circuit-switched channel or packet-switched channel associated with a second subscriber identity module according to the determination result while performing the packet-switched service with the first subscriber identity module.

2. The method of claim 1, wherein the adjusting step further comprises:
decreasing the frequency when the packet loss status indicates that the packet in the downlink transmission is not received successfully.

3. The method of claim 2, further comprising:
determining whether the frequency is equal to or less than a minimum threshold value; and
if the frequency is equal to or less than the minimum threshold value, stopping the decreasing of the frequency.

4. The method of claim 1, wherein the adjusting step further comprises:
increasing the frequency when the packet loss status indicates that at least a number of packets in the downlink transmission have been successfully received.

5. The method of claim 4, further comprising:
determining whether the frequency equals to or has exceeded a maximum threshold value; and
if the frequency equals to or has exceeded the maximum threshold value, stopping the increasing of the frequency.

6. The method of claim 5, wherein the maximum threshold value is configured by a service network which the mobile communications device camps on.

7. The method of claim 1, wherein the adjusting step further comprises:
increasing the frequency when the packet loss status indicates a ratio that at least a number of packets which are received in the downlink transmission can be decoded successfully has exceeded a predetermined ratio.

8. The method of claim 7, further comprising:
determining whether the frequency equals to or has exceeded a maximum threshold value; and
if the frequency equals to or has exceeded the maximum threshold value, stopping the increasing of the frequency.

9. The method of claim 1, wherein the control channel comprises a paging channel.

10. The method of claim 1, wherein the packet is a Layer 2 packet configured in an unacknowledged mode.

11. A mobile communications device, comprising:
a processing unit, performing a packet-switched (PS) service with a first subscriber identity module, determining a packet loss status regarding whether a packet in the downlink transmission have been successfully received during performing the PS service with the first subscriber identity module, and adaptively adjusting a frequency for receiving signals on control channel or circuit-switched channel associated with the first subscriber identity module or signals on control channel or circuit-switched channel or packet-switched channel associated with a second subscriber identity module according to the determination result while performing the PS service with the first subscriber identity module.

12. The mobile communications device of claim 11, wherein the processing unit further decreases the frequency when the packet loss status indicates that the packet in the downlink transmission is not received successfully.

13. The mobile communications device of claim 12, wherein the processing unit further determines whether the frequency is equal to or less than a minimum threshold value, and if the frequency is equal to or less than the minimum threshold value, stops the decreasing of the frequency.

14. The mobile communications device of claim 11, wherein the processing unit further increases the frequency when the packet loss status indicates that at least a number of packets in the downlink transmission have been successfully received.

15. The mobile communications device of claim 14, wherein the processing unit further determines whether the frequency equals to or has exceeded a maximum threshold value, and if frequency equals to or has exceeded the maximum threshold value, stops the increasing of the frequency.

16. The mobile communications device of claim 15, wherein the maximum threshold value is configured by a service network which the mobile communications device camps on.

17. The mobile communications device of claim 11, wherein the processing unit further increases the frequency when the packet loss status indicates a ratio that at least a number of data packets which are received in the downlink transmission can be decoded successfully has exceeded a predetermined ratio.

18. The mobile communications device of claim 17, wherein the processing unit further determines whether the frequency equals to or has exceeded a maximum threshold value, and if the frequency equals to or has exceeded the maximum threshold value, stops the increasing of the frequency.

19. The mobile communications device of claim 11, wherein the control channel comprises a paging channel.

20. The mobile communications device of claim 11, wherein the packet is a Layer 2 packet configured in an unacknowledged mode.
